(19) United States
(12) Patent Application Publication
(10) Pub. No.: US 2026/0089120 A1
(43) Pub. Date: Mar. 26, 2026

(54) Stable Allocation of Labels for Network Traffic Policies

(71) Applicant: Arista Networks, Inc., Santa Clara, CA (US)

(72) Inventors: Ramakrishna PADUVALLI, Saratoga, CA (US); Muhammad Khalid YOUSUF, San Jose, CA (US); Michael CHEN, Palo Alto, CA (US); Edward XIE, Belmont, MA (US)

(21) Appl. No.: 18/897,664

(22) Filed: Sep. 26, 2024

(51) Int. Cl. H04L 47/80; H04L 47/78

(52) U.S. Cl. CPC H04L 47/801; H04L 47/781

(57) ABSTRACT

Techniques for performing stable allocation of encoded labels for a traffic policy are provided. “Stable allocation” refers to allocating the encoded labels in a manner that reduces or minimizes the number of label changes caused by an upgrade of the traffic policy, thereby improving the latency of the upgrade process and increasing the likelihood that the upgrade can be completed hitlessly (i.e., without any service disruption or traffic loss).

### BACKGROUND

A network traffic policy (hereinafter simply “traffic policy”) is a set of rules that governs how network traffic (i.e., packets) are handled by a network device such as a switch or router. Each rule in a traffic policy specifies one or more fields (corresponding to packet header fields such as source Internet Protocol (IP) address, destination IP address, source port, destination port, etc.) and a list of match patterns per field, as well as an action (e.g., permit, deny, redirect, etc.). When a packet is received or sent out on a network device interface that is configured with a traffic policy, the packet is evaluated against the policy's rules to identify a rule that matches the packet (or in other words, a rule whose match patterns match respective field values in the packet's header). The action of the matched rule is then executed on the packet.

Traffic policy rules are typically programmed into a network device's ternary content-addressable memory (TCAM) to enable high-speed matching of the rules against incoming or outgoing packets. Field summarization is a technique that reduces the number of TCAM entries needed to program each rule in the TCAM. This technique generally involves allocating encoded (binary) labels to disjoint sets of match patterns for a given field and programming the encoded labels, rather than the match patterns, into the TCAM for that field.

Because each encoded label can represent multiple match patterns and because the encoded labels can be selectively masked in the TCAM using binary masking (thereby allowing a single TCAM entry to match a range of encoded labels), field summarization can save a significant amount of TCAM space. However, existing techniques for implementing field summarization (and in particular, for allocating encoded labels) can also cause problems in certain scenarios, such as when carrying out hitless traffic policy upgrades.

### BRIEF DESCRIPTION OF THE DRAWINGS

With respect to the discussion to follow and in particular to the drawings, it is stressed that the particulars shown represent examples for purposes of illustrative discussion and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts an example network device.

FIG. 2 depicts a label allocation algorithm.

FIG. 3 depicts a modified version of the network device of FIG. 1 in accordance with certain embodiments of the present disclosure.

FIGS. 4A and 4B depict a modified version of the label allocation algorithm of FIG. 2 in accordance with certain embodiments of the present disclosure.

### DETAILED DESCRIPTION

In the following description, for purposes of explanation, numerous examples and details are set forth in order to provide an understanding of embodiments of the present disclosure. Particular embodiments as expressed in the claims may include some or all of the features in these examples, alone or in combination with other features described below, and may further include modifications and equivalents of the features and concepts described herein.

Embodiments of the present disclosure are directed to techniques for performing stable allocation of encoded labels for a traffic policy. “Stable allocation” refers to allocating the encoded labels in a manner that reduces or minimizes the number of label changes caused by an upgrade of the traffic policy, thereby improving the latency of the upgrade process and increasing the likelihood that the upgrade can be completed hitlessly (i.e., without any service disruption or traffic loss).

### 1. Example Network Device

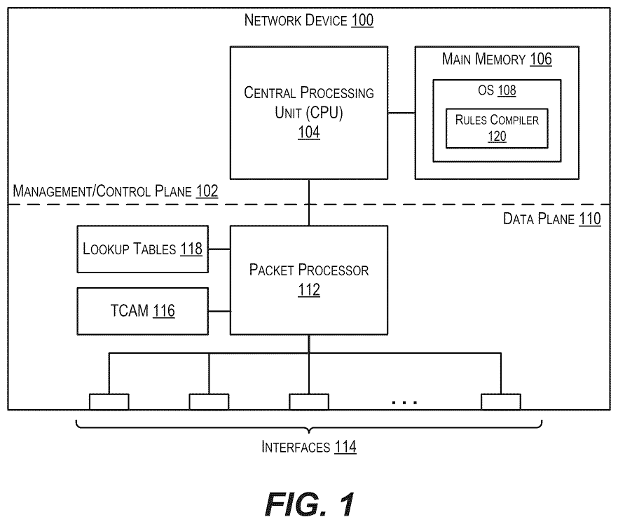

FIG. 1 is a simplified block diagram of an example network device 100 (e.g., switch, router, etc.) in which the techniques of the present disclosure may be implemented. As shown, network device 100 includes a management/control plane 102 comprising, among other things, a central processing unit (CPU) 104 and a main memory 106. CPU 104 is a general-purpose processor that is responsible for managing the configuration/operation of network device 100 and controlling the device's understanding of the network in which it resides. CPU 104 carries out these functions under the direction of an operating system (OS) 108 that runs on CPU 104 from main memory 106.

Network device 100 also includes a data plane 110 comprising, among other things, a packet processor 112 and a set of interfaces (ports) 114. Packet processor 112 is typically a specialized processor (e.g., an application-specific integrated circuit (ASIC) or field-programmable gate array (FPGA)) that is responsible for performing line-speed processing of network traffic that passes through network device 100 via interfaces 114. This line-speed processing includes the enforcement of traffic policies that are configured on one or more of the interfaces.

As mentioned previously, a traffic policy is a set of rules that govern the handling of packets that are received or sent out on a given interface, where each rule specifies one or more fields with corresponding lists of match patterns and one or more actions. The fields and their match patterns indicate which network packets match the rule. For example, a rule may specify a source IP address field with a list of match patterns comprising the IP prefixes 10.0.0.0/24 and 11.0.0.0/24, thereby indicating that any packets with a source IP address in the ranges of 10.0.0.0 to 10.0.0.255 and 11.0.0.0 to 11.0.0.255 match the rule. The action indicates how packet processor 112 should handle network packets that match the rule. Common traffic policy actions include “permit” (which means that a matched packet will be allowed to be forwarded to its destination), “deny” (which means that a matched packet will be dropped/blocked), and “redirect” (which means that a matched packet will be redirected to an alternative destination).

Traditionally, the traffic policies that are configured on a network device are programmed solely into a TCAM residing in the device's data plane, such as TCAM 116 shown in FIG. 1. A TCAM is a type of high-speed memory that enables fast, parallel searching of its contents. However, an issue with this traditional approach is that certain traffic policy rules may require the programming of multiple TCAM entries, depending on the number and type of match patterns per field that are specified in the rule. For example, consider a traffic policy rule that specifies the source IP address field with a list of four match patterns (prefixes) 4.1.1.1/32, 8.1.1.1/32, 16.1.1.1/32, and 32.1.1.1/32. This rule requires the programming of four separate TCAM entries (one for each source IP prefix), because these four source IP prefixes cannot be combined into a single, common IP prefix for TCAM lookup purposes. This is problematic because network device TCAMs are often small in size due to their high cost. For example, even in high-end switches and routers that are intended for use in large-scale deployments, TCAM size is limited to a few hundred megabytes (MB) at most. Thus, in many cases, the TCAM of a network device will be too small to accommodate all of the traffic policy rules configured on the device.

To mitigate this problem, network device 100 of FIG. 1 employs an existing feature known as field summarization. As noted in the Background section, field summarization involves allocating encoded labels to disjoint sets of match patterns for each field specified in the rules of a traffic policy. These encoded labels are programmed into TCAM 116 and the match pattern-to-encoded label mappings are programmed into a separate set of lookup tables 118 (which are less expensive, and thus larger in capacity, than TCAM 116). Because each encoded label can represent multiple match patterns and because the encoded labels can be selectively masked in the TCAM using binary masking (thereby allowing a single TCAM entry to match a range of encoded labels), field summarization can significantly reduce the number of TCAM entries required for implementing a traffic policy, particularly if the policy comprises rules that specify multiple, non-combinable match patterns per field.

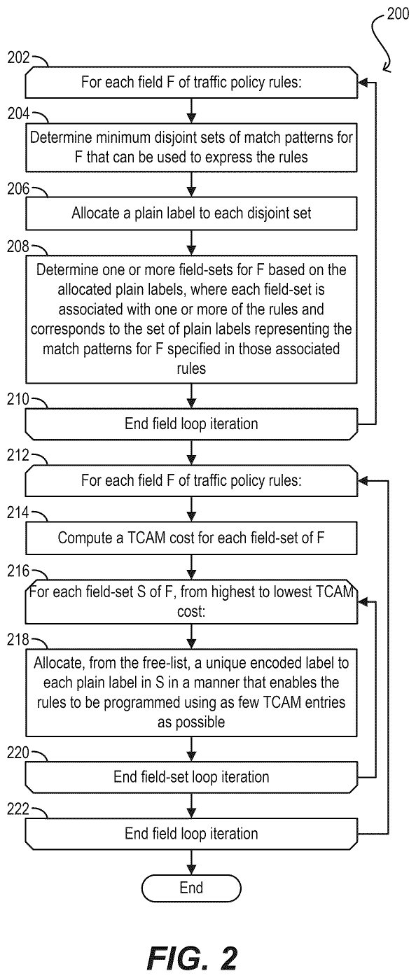

FIG. 2 depicts a conventional algorithm 200 that is executed by network device 100 for allocating (or in other words, assigning) encoded labels for a traffic policy T comprising n rules R1, . . . , Rn using field summarization. Algorithm 200 is typically executed in software (i.e., by CPU 104) via a traffic policy rules compiler, such as rules compiler 120 shown within OS 108 of network device 100.

Starting with step 202, network device 100 enters a first loop for each field F of rules R1, . . . , Rn for which field summarization is enabled. Within this first loop, network device 100 determines the minimum disjoint (i.e., non-overlapping) sets of match patterns for field F that can be used to express rules R1, . . . , Rn (step 204). “Minimum” in this context refers to the smallest possible number of such disjoint match pattern sets. For example, assume traffic policy T includes three rules R1, R2, and R3 as shown below:

TABLE 1

| Rule | Field: Match pattern(s) | Action |
|---|---|---|
| R1 | Source IP: 4.1.1.1/32, 8.1.1.1/32, 16.1.1.1/32, | Permit |
| | 32.1.1.1/32 | |
| R2 | Source IP: 4.1.1.1/32, 16.1.1.1/32 | Redirect |
| R3 | Source IP: 64.1.1.1/32 | Deny |

In this scenario, the minimum disjoint match pattern sets determined for the source IP address field will comprise three sets: a first set [4.1.1.1/32, 16.1.1.1/32] that can be used to represent the match patterns for the source IP address field in R2, a second set [8.1.1.1/32, 32.1.1.1/32] that can be used in conjunction with the first set to represent the match patterns for the source IP address field in R1, and a third set [64.1.1.1/32] that can be used to represent the match pattern for the source IP address field in R3. Note that another possible disjoint set permutation in this scenario comprises five sets [4.1.1.1/32], [8.1.1.1/32], [16.1.1.1/32], [32.1.1.1/32], and [64.1.1.1/32], but this permutation would not be a “minimum” permutation.

At step 206, network device 100 allocates an initial, or “plain”, label to each disjoint set determined at step 204. This plain label can be any type of symbol or sequence of symbols (e.g., numbers, letters, etc.) that uniquely identifies the disjoint set. For instance, in the example above the first set [4.1.1.1/32, 16.1.1.1/32] can be allocated the plain label “A”, the second set [8.1.1.1/32, 32.1.1.1/32] can be allocated the plain label “B”, and the third set [64.1.1.1/32] can be allocated the plain label “C”.

At step 208, network device 100 determines one or more field-sets for field F based on the allocated plain labels, where each field-set is associated with one or more of rules R1, . . . , Rn and corresponds to the set of plain labels representing the match patterns for F specified in those associated rules. For instance, in the example above network device 100 will determine three field-sets S1, S2, and S3 where S1 is associated with rule R2 and corresponds to the plain label set {A}, S2 is associated with rule R1 and corresponds to the plain label set {A, B}, and S3 is associated with rule R3 and corresponds to the plain label set {C}.

At step 210, network device 100 reaches the end of the current loop iteration for the first loop and returns to step 202 in order to process the next field. Upon processing all fields, network device 100 enters a second loop for each field F of rules R1, . . . , Rn for which feature summarization is enabled (step 212). Within this second loop, network device 100 computes a TCAM cost for each field-set S determined in the first loop for field F (step 214). This TCAM cost generally indicates the number of TCAM entries that need to be programmed into TCAM 116 for field-set S. In one set of embodiments, the TCAM cost can be computed by multiplying the number of rules associated with field-set S by the number of plain labels in S.

At step 216, network device 100 enters a third loop for each field-set S for field F, in order from highest TCAM cost to lowest TCAM cost. Within this third loop, network device 100 allocates, from a domain of available encoded (binary) labels (referred to as the “free-list”), a unique encoded label to each plain label in field-set S, such that rules R1, . . . , Rn can be programmed into TCAM 116 using as few TCAM entries as possible (step 218).

The specific details on how these encoded labels are chosen is beyond the scope of the present disclosure, but the general idea is that, to the extent possible, the plain labels (and thus, the disjoint match pattern sets) in the field-sets of field F are allocated encoded labels from one or more continuous ranges, or blocks, of positive integers; this allows the rules associated with those field-sets to be consolidated into a relatively small number of TCAM entries using binary masking. For instance, in the example above where the source IP address field has three field sets S1={A}, S2={A, B}, and S3={C}, plain label A can be allocated the encoded label 0 (Ob0000 in binary), plain label B can be allocated the encoded label 1 (0b0001 in binary), and plain label C can be allocated the encoded label 2 (0b0010 in binary). This allows rule R1 to be programmed into TCAM 116 using a single TCAM entry with a match criterion of source IP address==0b000X (where X is masked bit and therefore can be either 0 or 1), rule R2 to be programmed into TCAM 116 using a single TCAM entry with a match criterion of source IP address==0b0000, and rule R3 to be programmed to into TCAM 116 using a single TCAM entry with a match criterion of source IP address==0b0010.

At step 220, network device 100 reaches the end of the current loop iteration for the third loop and returns to step 216 in order to process the next field-set for field F. Further, at step 222, network device 100 reaches the end of the current loop iteration for the second loop and returns to step 212 in order to process the next field. Finally, upon finishing this second loop, the label allocation process is complete and network device 100 can program rules R1, . . . , Rn into lookup tables 118 and TCAM 116 using the allocated encoded labels. For instance, the following table presents the lookup table entries that are programmed into lookup tables 118 for rules R1-R3 in the scenario where plain labels A, B, and C are allocated encoded labels 0b0000, 0b0001, and 0b0010 respectively:

TABLE 2

| Match criterion | Encoded label |
|---|---|
| Source IP == 4.1.1.1/32 | 0b0000 |
| Source IP == 8.1.1.1/32 | 0b0001 |
| Source IP == 16.1.1.1/32 | 0b0000 |
| Source IP == 32.1.1.1/32 | 0b0001 |
| Source IP == 64.1.1.1/32 | 0b0010 |

And the following table presents the TCAM entries that are programmed into TCAM 116 for rules R1-R3 in this scenario. As can be seen, only three TCAM entries are needed for these rules, which is less than the number of entries (five) that would be needed if the rules were directly programmed into the TCAM without feature summarization.

TABLE 3

| Match criterion | Action |
|---|---|
| Source IP == 0b000X | Permit |
| Source IP == 0b0001 | Redirect |
| Source IP == 0b0010 | Deny |

### 2. Solution Overview

One property of the existing label allocation algorithm shown in FIG. 2 is that the encoded labels are not “anchored” to a particular field-set or a particular traffic policy rule, which means that when the traffic policy is updated the majority of the encoded labels allocated for the policy will change (even if only a single rule is modified). This property, referred to herein as label instability, means that a significant percentage of new/different TCAM entries need to be programmed in order to implement the updated traffic policy.

Label instability is particularly problematic for carrying out a hitless traffic policy upgrade, or in other words an upgrade of a traffic policy from an old version (e.g., v1) to a new version (e.g., v2) that does not disrupt the traffic flowing through the network device. Such a hitless upgrade is commonly performed by compiling three lists of TCAM entries: a first list with entries unique to the old version, a second list with entries unique to the new version, and a third list with entries that are common to both versions. The network device then removes the entries in the first list (i.e., those unique to the old version) and inserts the entries in the second list (i.e., those unique to the new version), while leaving the common entries in place. The problem here is that the label allocation algorithm of FIG. 2 will generally cause the number of common entries to be very small in nearly all upgrade scenarios due to label instability. This in turn increases the number of TCAM entries that need to be removed and/or inserted during the hitless upgrade process, leading to longer upgrade times and, in some cases, upgrade failure.

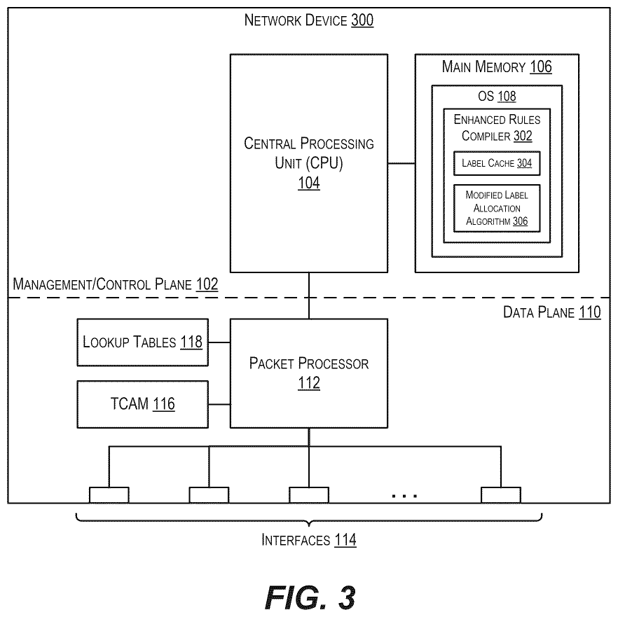

To address the foregoing and other related problems, FIG. 3 depicts a modified version 300 of network device 100 that includes an enhanced rules compiler 302 comprising a label cache 304 and a modified label allocation algorithm 306 according to certain embodiments. At a high level, modified label allocation algorithm 306 changes the way in which the network device allocates encoded labels to the plain labels of a field-set S by checking whether an appropriately-sized block of encoded labels was previously allocated to one or more traffic policy rules associated with S in a prior run of the algorithm (or in other words, for a prior version of the traffic policy). This check is performed by accessing label cache 304, where each entry in cache 304 identifies a rule R of a traffic policy T (e.g., rule “T-R”), a block of one or more previously-allocated encoded labels for T-R, and the number of plain labels to which those encoded labels were allocated (referred to as the plain label count). If the answer to the check is yes, the previously-allocated encoded labels are reused for field-set S. On the other hand, if the answer to the check is no, a new block of encoded labels is allocated for the plain labels of field-set S from the free-list (i.e., the domain of available encoded labels).

With this general approach, modified label allocation algorithm 306 can significantly improve the stability of the encoded labels allocated for a traffic policy across different versions, because previously-allocated labels are reused to the extent possible. Accordingly, algorithm 306 advantageously reduces the amount of hardware resources and time needed to carry out hitless traffic policy upgrades.

It should be appreciated that FIGS. 1-3 are illustrative and not intended to limit embodiments of the present disclosure. For example, although FIGS. 1 and 3 depict a particular arrangement of components in network device 100/300, other arrangements are possible (e.g., the functionality attributed to a particular component may be split into multiple components, components may be combined, etc.). One of ordinary skill in the art will recognize other similar variations, modifications, and alternatives.

### 3. Modified Label Allocation Algorithm

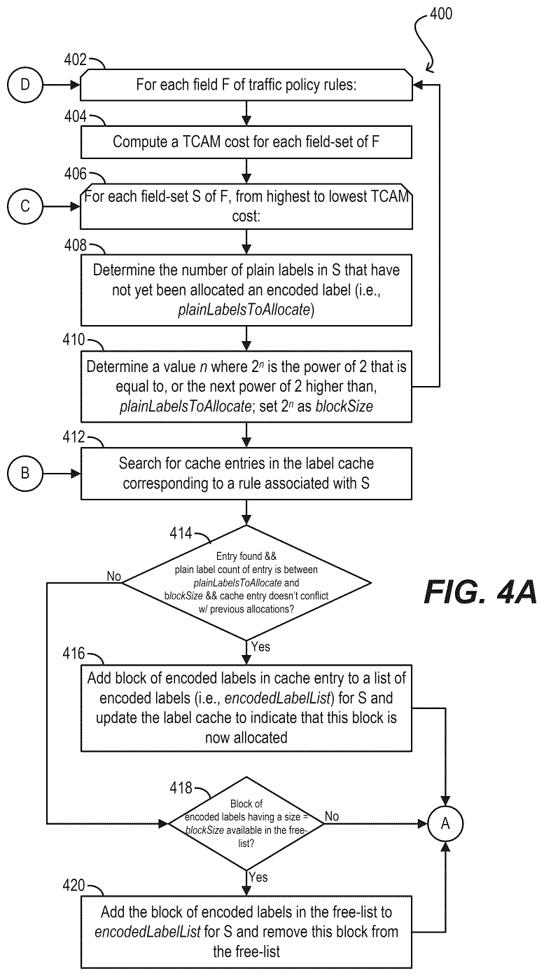

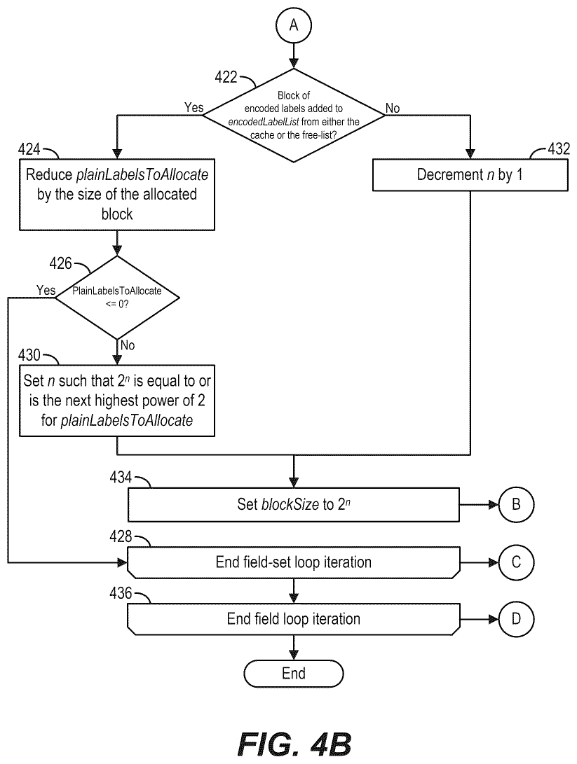

FIGS. 4A and 4B depict a workflow 400 that may be executed by network device 300 of FIG. 3 using its modified label allocation algorithm 306 for allocating encoded labels to a traffic policy T comprising n rules R1, . . . , Rn according to certain embodiments. Workflow 400 replaces steps 212-222 of existing label allocation algorithm 200 and thus assumes that steps 202-210 of algorithm 200 have been executed (and more specifically, that the field-sets for the traffic policy have been created) before workflow 400 begins.

Starting with step 402 of FIG. 4A, network device 300 can enter a second loop (in the context of algorithm 200) for each field F of rules R1, . . . , Rn for which feature summarization is enabled. Within this second loop, network device 300 can compute a TCAM cost for each field-set S determined for field F (step 404). As mentioned previously, this TCAM cost generally indicates the number of TCAM entries that need to be programmed into TCAM 116 for field-set S.

At step 406, network device 300 can enter a third loop (in the context of algorithm 200) for each field-set S for field F, in order from highest TCAM cost to lowest TCAM cost. Within this third loop, network device 100 can determine the number of plain labels in field-set S that have not yet been allocated an encoded label (represented using the variable plainLabelsToAllocate) (step 408). Network device 300 can then determine a value n where 2ⁿ is the power of 2 that is equal to, or the next power of 2 higher than, plainLabelsToAllocate (step 410). For example, if plainLabelsToAllocate=5, n=3 because 5 is not a power of 2 and the next power of 2 higher than 5 is 23=8. This power of 2 value is represented using the variable blockSize.

At step 412, network device 300 can search for one or more cache entries in label cache 304 corresponding to a rule of traffic policy T that is associated with field-set S. If such a matching cache entry is found, if the plain label count of that cache entry falls between plainLabelsToAllocate and blockSize (i.e., plainLabelsToAllocate<=plain label count<=blockSize), and if the cache entry does not conflict with previous allocations of the plain labels to be allocated in field-set S (step 414), network device 300 can add the block of encoded labels included in the cache entry to a list of encoded labels (i.e., encodedLabelList) for field-set S and can update the cache to indicate that this block is now allocated to the plain labels in S (step 416).

Alternatively, if no matching cache entry is found or if the plain label count of a matching cache entry does not fall between plainLabelsToAllocate and blockSize, network device 300 can check whether a block of encoded labels having a size equal to blockSize is available in the free-list (step 418). If the answer is yes, network device 300 can add the available block of encoded labels in the free-list to encodedLabelList can remove that block from the free-list (step 420).

Turning now to FIG. 4B, at step 422 network device 300 can check whether a block of encoded labels was allocated for field-set S (i.e., added to its encodedLabelList) from either label cache 304 (per step 416) or from the free-list (per step 420). If the answer is yes, network device 300 can reduce plainLabelsToAllocate by the size of the allocated block (step 424). Further, if plainLabelsToAllocate is now less than or equal to zero (step 426), network device 300 can proceed to the end of the current iteration of the third loop (step 428); otherwise, network device 300 can set n such that 2ⁿ is equal to or is the next highest power of 2 for plainLabelsToAllocate (step 430).

On the other hand, if the answer at step 422 is no (i.e., no block was allocated), network device 300 can decrement n by 1 (step 432).

Network device 300 can thereafter set blockSize to 2ⁿ (step 434) can return to step 412 in order to repeat its search of label cache 304. Once all of the field-sets for field F have been processed in this manner, network device 300 can reach the end of the current loop iteration for the second loop (step 436) and return to step 402 in order to process the next field. Finally, once all of the fields of traffic policy T have been processed, workflow 400 can end.

Upon completion of this process, each field-set of each field of traffic policy T will have an encodedLabelList identifying the encoded labels for that field-set, which network device 300 can use to program lookup tables 118 and TCAM 116. In addition, although not shown, network device 300 can update label cache 304 to remove any encoded labels that were not allocated in this run of the algorithm, as well as to add encoded labels that were newly allocated from the free-list.

To further clarify the operation of modified label allocation algorithm 306, consider an initial version v1 of traffic policy T as shown below:

TABLE 4

| Rule | Field: Match pattern(s) | Action |
|---|---|---|
| R1 | Source IP: 4.1.1.1/32 | Permit |
| R2 | Source IP: 4.1.1.1/32 | Deny |
| R3 | Source IP: 8.1.1.1/32 | Deny |

When modified label allocation algorithm 306 is first run on version v1, the algorithm will determine a first source IP address field-set S1 comprising a plain label for [4.1.1.1/32], assign to that plain label an encoded label from the free-list (say 0b0100), determine a second source IP address field-set S2 comprising a plain label for [8.1.1.1/32], assign to that plain label an encoded label from the free-list (say Ob1000), and populate label cache 304 with the following three cache entries (one per rule). Each of these cache entries takes the form PolicyName-RuleName=→{plain label count: [[encoded labels]]}.

Listing 1

T-R1 → {1: [ [0b0100] ]}
T-R2 → {1: [ [0b0100] ]}
T-R3 → {1: [ [0b1000] ]}

Now assume v1 of traffic policy T is updated to version v2 as shown below:

TABLE 5

| Rule | Field: Match pattern(s) | Action |
|---|---|---|
| R1 | Source IP: 4.1.1.1/32, 8.1.1.1/32 | Permit |
| R2 | Source IP: 4.1.1.1/32 | Deny |
| R3 | Source IP: 8.1.1.1/32 | Deny |

When modified label allocation algorithm 306 is run on version v2, the algorithm will determine two source IP address field-sets: a first field-set S1 associated with rule R2 and comprising the single plain label for [4.1.1.1/32], a second field-set S2 associated with rule R3 comrising the single plain label for [8.1.1.1/32], and a third field-set S3 associated with rule R1 comprising the two plain labels for [4.1.1.1/32] and [8.1.1.1/32] from S1 and S2 respectively. Further, the algorithm will:
1. Process field-set S3 of rule R1 first (because S3 has a higher TCAM count than S1 or S2), determine that there is an existing cache entry for R1 but the plain label count of this cache entry (i.e., 1) is less than the number of plain labels to allocate for S3 (i.e., 2), and thus allocate encoded labels to the plain labels for [4.1.1.1/32] and [8.1.1.1/32] from the free-list (say 0b0001 and 0b0011).
2. Process field-set S1 of rule R2 second, determine that there is an existing cache entry for R2 with a plain label count (i.e., 1) greater than or equal to the number of plain labels to allocate for S1 (i.e., 1), but the encoded label in the existing cache entry falls outside of encoded labels allocated via rule R1. Accordingly, allocate an encoded label previously allocated via R1 (say 0b0001) to the plain label in S1. Note that because field-set S1 of rule R2 and field-set S2 of rule R3 have the same TCAM count, it is possible for S2 to be processed before S1.
3. Process field-set S2 of rule R3 third, determine that there is an existing cache entry for R3 with a plain label count (i.e., 1) greater or equal to the number of plain labels to allocate for S2 (i.e., 1), but the encoded label in the existing cache entry falls outside of the encoded labels allocated via rule R1. Accordingly, allocate an encoded label previously allocated via R1 to the plain label in S2. Because Ob0001 has already been allocated, allocate 0b0011.

Upon completion of this second run of the algorithm, label cache 304 will include the following three cache entries:

Listing 2

T-R1 → {2: [ [0b00X1] ]}
T-R2 → {1: [ [0b0001] ]}
T-R3 → {1: [ [0b0011] ]}

Now assume v2 of traffic policy T is updated to version v3 as shown below:

TABLE 6

| Rule | Field: Match pattern(s) | Action |
|---|---|---|
| R1 | Source IP: 4.1.1.1/32, 8.1.1.1/32, 16.1.1.1/32 | Permit |
| R2 | Source IP: 4.1.1.1/32 | Deny |
| R3 | Source IP: 8.1.1.1/32, 16.1.1.1/32 | Deny |

When modified label allocation algorithm 306 is run on version v3, the algorithm will determine three source IP address field-sets: a first field-set S1 associated with rule R2 and comprising the single plain label for [4.1.1.1/32], a second field-set S2 associated with rule R3 and comprising a single plain label for [8.1.1.1/32, 16.1.1.1/32], and a third field-set S3 associated with rule R1 and comprising the two plain labels for [4.1.1.1/32] and [8.1.1.1/32, 16.1.1.1/32] from S1 and S2 respectively. Further, the algorithm will:
1. Process field-set S3 of rule R1 first (because S3 has a higher TCAM count than S1 or S2), determine that there is an existing cache entry for this field-set associated with rule R1 with a plain label count (i.e., 2) greater than or equal to the number of plain labels to allocate for S3 (i.e., 2), and thus re-use the encoded labels 0b0001 and 0b0011 for [4.1.1.1/32] and [8.1.1.1/32, 16.1.1.1./32].
2. Process field-set S1 of rule R2 second, determine that there is an existing cache entry for this field-set associated with rule R2 with a plain label count (i.e., 1) greater than or equal to the number of plain labels to allocate for S1 (i.e., 1), and thus re-use the encoded label allocated to the plain label for [4.1.1.1/32] (which is 0b0001).
3. Process field-set S2 of rule R3 third, determine that there is an existing cache entry for this field-set associated with rule R3 with a plain label count (i.e., 1) greater than or equal to the number of plain labels to allocate for S1 (i.e., 1), and thus re-use the encoded label allocated to the plain label for [8.1.1.1/32, 16.1.1.1/32] (which is 0b0011).

Note that, although rules R1 and R3 are changed between versions v2 and v3 of traffic policy T to include an additional source IP match pattern (16.1.1.1/32), there is no change to the encoded labels for the source IP address field-sets of rules R1, R2, and R3, and thus no change to the TCAM entries that need to be programmed for these rules.

### 4. Comparing Allocation Results Using the Label Cache+Free-List and the Free-List Only

In some edge cases, the use of modified label allocation algorithm 306 can result in a suboptimal label allocation when compared to existing algorithm 200. To address this, in certain embodiments network device 300 can run both algorithms on a traffic policy, resulting in the creation of two sets of encoded label lists: a first set generated using the label cache 304+the free-list per algorithm 306 and a second set generated using the free-list only (per algorithm 200). Network device 300 can then check whether any field-set of the traffic policy has an encoded label list in the first set that is greater in size than the corresponding encoded label list in the second set.

If the answer is no, network device 300 can use the first set of encoded label lists to program the traffic policy rules into lookup tables 118 and TCAM 116. On the other hand, if the answer is yes, network device 300 can use the second set of encoded label lists to program the rules, thereby reverting to conventional “unstable” label allocation. The rationale behind this approach is that the reduction in TCAM usage achieved by using the second set of encoded label lists (in the case where this second set includes one or more smaller encoded label lists) will likely be more beneficial for facilitating hitless upgrades than the label stability provided by using the first set.

The above description illustrates various embodiments of the present disclosure along with examples of how aspects of these embodiments may be implemented. The above examples and embodiments should not be deemed to be the only embodiments and are presented to illustrate the flexibility and advantages of the present disclosure as defined by the following claims. For example, although certain embodiments have been described with respect to particular workflows and steps, it should be apparent to those skilled in the art that the scope of the present disclosure is not strictly limited to the described workflows and steps. Steps described as sequential may be executed in parallel, order of steps may be varied, and steps may be modified, combined, added, or omitted. As another example, although certain embodiments may have been described using a particular combination of hardware and software, it should be recognized that other combinations of hardware and software are possible, and that specific operations described as being implemented in hardware can also be implemented in software and vice versa.

The specification and drawings are, accordingly, to be regarded in an illustrative rather than restrictive sense. Other arrangements, embodiments, implementations, and equivalents will be evident to those skilled in the art and may be employed without departing from the spirit and scope of the present disclosure as set forth in the following claims.

1. A method performed by a network device for allocating encoded labels for a traffic policy comprising a plurality of rules, the method comprising:
determining a set of fields specified in one or more of the plurality of rules; and
for each field in the set of fields:
determining one or more field-sets for the field, each field-set being associated with one or more rules in the plurality of rules and corresponding to a set of plain labels representing match patterns for the field in the one or more rules; and
for each field-set in the one or more field-sets:
determining a number of plain labels in the field-set that have not yet been allocated an encoded label;
determining a block size based on the number of plain labels;
searching a label cache for a cache entry corresponding to a rule in the one or more rules; and
upon finding the cache entry in the label cache and determining that a plain label count in the cache entry is between the number of plain labels and the block size, allocating a first block of encoded labels specified in the cache entry to the field-set.

2. The method of claim 1 wherein the set of fields correspond to packet header fields.

3. The method of claim 1 further comprising, upon failing to find the cache entry in the label cache or determining that the plain label count in the cache entry is not between the number of plain labels and the block size:
checking whether a second block of encoded labels having a size equal to the block size is available in a domain of available encoded labels; and
upon determining that the second block of encoded labels is available in the domain of available encoded labels, allocating the second block of encoded labels to the field-set.

4. The method of claim 3 wherein the block size is a nearest power of 2 equal to or greater than the number of plain labels.

5. The method of claim 4 further comprising, upon determining that the first block of encoded labels or the second block of encoded labels was allocated to the field-set:
reducing the number of plain labels by a size of the first block or the second block; and
upon determining that the reduced number of plain labels remains greater than zero, setting the block size to a nearest power of 2 equal to or greater than the reduced number of plain labels and repeating the searching of the label cache.

6. The method of claim 4 further comprising, upon determining that neither the first block of encoded labels nor the second block of encoded labels was allocated to the field-set:
setting the block size to a next lower power of 2 and repeating the searching of the cache.

7. The method of claim 1 further comprising, upon processing all fields in the set of fields:
updating the label cache to remove any encoded labels that remain unallocated and to add any encoded labels that were allocated from the domain of available encoded labels.

8. The method of claim 1 further comprising:
computing a ternary content-addressable memory (TCAM) cost for each field-set in the one or more field-sets.

9. The method of claim 8 wherein said each field-set is processed in order from highest TCAM cost to lowest TCAM cost.

10. A network device comprising:
a central processing unit (CPU);
a set of lookup tables;
a ternary content-addressable memory (TCAM); and
a main memory having stored thereon program code that, when executed by the CPU, causes the CPU to:
determine a set of fields specified in one or more of a plurality of rules of a traffic policy; and
for each field in the set of fields:
determine one or more field-sets for the field, each field-set being associated with one or more rules in the plurality of rules and corresponding to a set of plain labels representing match patterns for the field in the one or more rules; and
for each field-set in the one or more field-sets:
determine a number of plain labels in the field-set that have not yet been allocated an encoded label;
determine a block size based on the number of plain labels;
search a label cache for a cache entry corresponding to a rule in the one or more rules; and
upon finding the cache entry in the label cache and determining that a plain label count in the cache entry is between the number of plain labels and the block size, allocate a first block of encoded labels specified in the cache entry to the field-set.

11. The network device of claim 10 wherein the set of fields correspond to packet header fields.

12. The network device of claim 10 wherein the program code further causes the CPU to, upon failing to find the cache entry in the label cache or determining that the plain label count in the cache entry is not between the number of plain labels and the block size:
check whether a second block of encoded labels having a size equal to the block size is available in a domain of available encoded labels; and
upon determining that the second block of encoded labels is available in the domain of available encoded labels, allocate the second block of encoded labels to the field-set.

13. The network device of claim 12 wherein the block size is a nearest power of 2 equal to or greater than the number of plain labels.

14. The network device of claim 13 wherein the program code further causes the CPU to, upon determining that the first block of encoded labels or the second block of encoded labels was allocated to the field-set:
reduce the number of plain labels by a size of the first block or the second block; and
upon determining that the reduced number of plain labels remains greater than zero, set the block size to a nearest power of 2 equal to or greater than the reduced number of plain labels and repeat the searching of the label cache.

15. The network device of claim 13 wherein the program code further causes the CPU to, upon determining that neither the first block of encoded labels nor the second block of encoded labels was allocated to the field-set:
set the block size to a next lower power of 2 and repeat the searching of the cache.

16. The network device of claim 10 wherein the program code further causes the CPU to, upon processing all fields in the set of fields:
update the label cache to remove any encoded labels that remain unallocated and to add any encoded labels that were allocated from the domain of available encoded labels.

17. The network device of claim 10 wherein the program code further causes the CPU to:
compute a TCAM cost for each field-set in the one or more field-sets.

18. The network device of claim 17 wherein said each field-set is processed in order from highest TCAM cost to lowest TCAM cost.

19. A method performed by a network device for allocating encoded labels for a traffic policy comprising a plurality of rules, the method comprising:
determining a set of fields specified in one or more of the plurality of rules; and
for each field in the set of fields:
determining one or more field-sets for the field, each field-set being associated with one or more rules in the plurality of rules and corresponding to a set of plain labels representing match patterns for the field in the one or more rules; and
for each field-set in the one or more field-sets:
determining a number of plain labels in the field-set that have not yet been allocated an encoded label;
determining, based on a label cache, whether a range of encoded labels equal in size to the number of plain labels was previously allocated to the field-set; and
upon determining that a range of encoded labels equal in size to the number of plain labels was previously allocated to the field-set, re-allocating the range of encoded labels to the field-set.

20. The method of claim 19 further comprising, upon determining that a range of encoded labels equal in size to the number of plain labels was not previously allocated to the field-set, allocating a new range of encoded labels equal in size to the number of plain labels to the field-set from a domain of available encoded labels.
